(19) United States
(12) Patent Application Publication
(10) Pub. No.: US 2012/0214114 A1
(43) Pub. Date: Aug. 23, 2012

(54) METHOD FOR COMPENSATING FLUE GAS ENTHALPY LOSSES OF HEAT-RECOVERY COKE OVENS

(75) Inventors: Ronald Kim, Essen (DE); Rainer Worberg, Bottrop (DE); Manfred Heyer, Herne (DE); Hans-Joachim Reichelt, Hattingen (DE)

(73) Assignee: THYSSENKRUPP UHDE GMBH, Dortmund (DE)

(21) Appl. No.: 13/508,357

(22) PCT Filed: Sep. 29, 2010
(86) PCT No.: PCT/EP2010/005919

§ 371 Date: May 5, 2012

(30) Foreign Application Priority Data
Nov. 9, 2009 (DE) 10 2009 052 282.4

(51) Int. Cl. F27D 7/00

(52) U.S. Cl. 432/19

(57) ABSTRACT

A method for compensating flue gas enthalpy losses of heat-recovery coke ovens, having a coke oven bank, connected to one or more boilers by one or more a flue gas channels. The operation of the coke oven chambers is periodically interrupted, during which time the coke cake is removed, and the individual coke oven chambers are kept hot during the interruption of the operation by an an externally fired additional burner providing hot flue gas. The resulting heat flow remains the same in comparison to the normal operation. In this way, the boilers, which are typically used to produce steam, can be operated economically.

The invention relates to a method for compensation of flue gas enthalpy losses from “Heat Recovery” coke ovens which recover steam or heated water from flue gas evolving during coal carbonization, with it being possible to interrupt the operation of coke oven chambers for a certain period of time so that the coke oven chamber contains no coke or a reduced quantity of coke and so that a non-desired cooling-off of the coke oven chambers is avoided by means of additional burners which keep on heating the coke oven chambers during said interruption of operation, and wherein the reduced amount of heat in flue gases is compensated for by means of at least one additional compensation burner located outside the coke oven chambers so that the boilers are supplied with a constant amount of heat.

The operation of coke oven chambers is performed in cycles which means that the coke ovens are charged in cycles, and that the coal is heated for production of coke and that the finished coke product is pushed out from the coking chamber for further use after coal carbonization. It frequently occurs that coke oven chambers are not charged instantly after coke pushing, because there are no storage capacities available or because production needs to be adapted to demand. Consequently the coke oven chambers are empty for a certain period of time or are just charged with a reduced amount of coke. A cooling-off of the coke oven chambers must be avoided because this would damage the structural materials of the coke oven chambers. A re-heating of the coke oven chambers would also require substantial energy and therefore it would be very expensive.

In principle it is possible to equip coke oven chambers with burners heated by external sources so that the coke oven chambers do not cool-off during the period of an operational interruption or delay. Thereby, however, a flue gas is frequently produced which has a substantially lower temperature. This is problematic because flue gas from coke oven chambers designed as “Heat Recovery” coke ovens is utilized in so-called boilers for the production of steam or heated water. If the temperature of flue gas is subject to fluctuations which differ from normal operation of coke ovens, the boiler(s) cannot be operated economically. The capacity of additional burners in coke oven chambers frequently fails to be sufficient for a further warming-up of flue gas in flue gas channels.

Methods for heating-up of flue gas in coke oven chambers are known from prior art in technology. U.S. Pat. No. 4,045,299 A discloses an arrangement of coke oven chambers with lateral coke oven chamber walls, frontal coke oven chamber doors, charging apertures in the ceiling and a coke oven chamber floor onto which the coal cake is loaded for coal carbonization. Beneath the floor, there are secondary air soles which stand in connection to the oven free gas space above the coke cake via channels arranged in the sides of the coke oven chamber. The secondary air soles, in turn, stand in connection with a heating chamber which is equipped with foreign-heated burners, thus making it possible to completely burn non-burnt residual gases in the coking gas before these are fed into the recuperator. If required, the heating chamber can be supplied with coking gas from the oven free gas space above the coke cake so that the flue gas is steadily burnt completely and provided with a temperature that is suitable for flue gas combustion. This constructive design, however, is only suitable for “Non-Recovery” coke ovens and it must be operated continuously to ensure an appropriately high temperature of the flue gas. A possibility to recover steam and to ensure constant temperature of flue gas is not described.

Now, therefore, it is the object of the present invention to provide a method that supplies a flue gas with a constantly high temperature during an operational interruption of coke oven chambers to generate steam or heated water and that at the same time prevents a non-desired cooling-off of the coke oven chambers.

The present invention solves this task by at least one compensation burner located outside the coke oven chamber and introducing the heated flue gas into the flue gas channel so that the heat enthalpy loss resulting from a scheduled or non-scheduled operational interruption of coke oven chambers can be compensated for by way of additionally fed-in flue gas. Thereby, a flue gas having a constant temperature is provided in the boilers so that the boilers can be operated economically.

Compensation burner(s) can be arranged outside the coke oven chamber at any arbitrary location. However, preference is given to a location upstream to the entrance near the flue gas distributor into the boiler.

Claim is laid in particular to a method for compensation of flue gas enthalpy losses from “Heat Recovery” coke ovens, wherein
a number of coke oven chambers is linked to a coke oven bank connected to at least one boiler which utilizes the hot flue gas from the coke oven banks to generate steam or heated water, and
the operation of coke oven chambers is periodically interrupted, removing coke from the coke oven chambers, and
in normal operation the coking gas is utilized to heat the coke cake by combustion with air and to supply the heat required for coal carbonization so that a hot flue gas is produced, and
the individual coke oven chambers during the period of scheduled or non-scheduled operational interruption are kept warm with at least one foreign-fired additional burner so that a hot flue gas originating from the flue gas of the burners is also provided during the period of operational interruption or delay,
   and which is characterized in that
the heat flow which is reduced as compared with normal operation is compensated for by at least one additional compensation burner located outside the coke oven chambers so that the boiler(s) is (are) supplied with a heat flow that is constant as compared with normal operation.

In the course of an operational interruption or delay, the heat flow of flue gas is typically reduced by up to 50 percent in so-called hot-idle mode without additional compensation burners arranged outside the coke oven chambers. But this is just a reference value. The reason is that the capacity of additional burners in coke oven chambers frequently fails to be sufficient to keep the flue gas at a constantly high temperature. In an advantageous embodiment of the present invention, the compensation burners are arranged upstream to the flue gas distributor which is located upstream to the boiler.

Depending on the construction type of compensation burners, the heat flow of flue gas is brought back to 100 percent or nearly 100 percent of the heat flow achieved in normal operation. This occurs temporally constant. Depending on the construction type, the performance rate of the compensation burner can be automated as a function of a temperature sensor.

Compensation burner(s) outside the coke oven chambers are preferably operated with a fuel containing hydrocarbons. In a preferred embodiment, this fuel is natural gas. In an embodiment of the inventive method, however, it is also possible to operate the additional compensation burner(s) with coke oven gas. In another embodiment of the inventive method, it is furthermore possible to operate the additional compensation burner(s) with evaporated liquid hydrocarbons or evaporated fuels containing hydrocarbons. In another embodiment of the process, it is furthermore possible to operate the additional compensation burner(s) with liquefied gas. This can be, for example, so-called LPG (Liquefied Petroleum Gas or Low Pressure Gas). The said gas can be kept liquid either by pressure or reduced temperature.

The heat flow or the enthalpy of flue gas is typically utilized to generate steam by means of the boilers. The steam is then utilized and exploited to generate electric current.

In an embodiment of the present invention, the compensation burners are arranged directly upstream to the boiler(s). In another embodiment, a lockable emergency chimney equipped with a locking device is arranged between the flue gas collecting duct and the boiler(s). The additional compensation burner(s) is (are) arranged directly upstream to the emergency chimney. In another embodiment of the present invention, the compensation burner(s) is (are) arranged in the discharge duct for flue gas between coke ovens and the boiler. The compensation burners can be provided in any arbitrary number and in any arbitrary combination in what concerns the arrangement of the compensation burners.

The present invention bears the advantage of providing a method that supplies a flue gas with a constantly high temperature during an operational interruption of coke oven chambers and which at the same time prevents a non-desired cooling-off of coke oven chambers. Consequently, the boilers can be run economically.

The invention is explained by way of two drawings, these drawings just representing exemplary embodiments of the present invention.

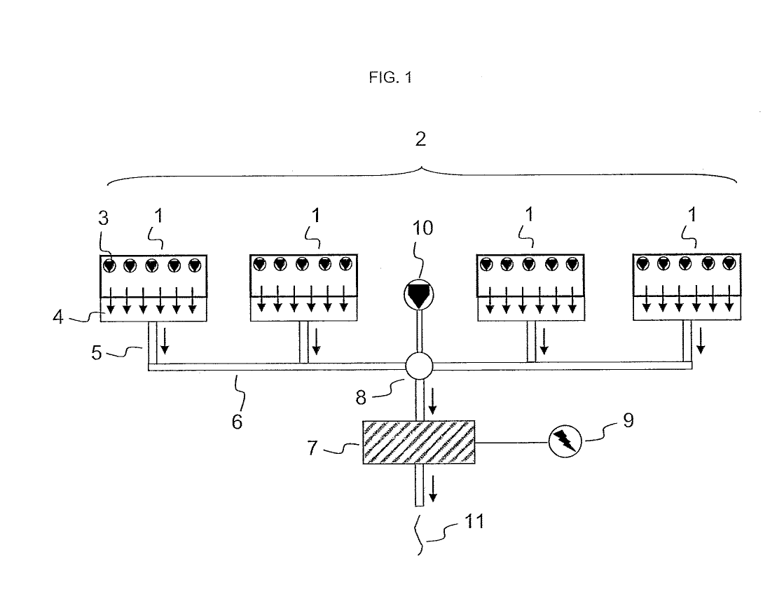

FIG. 1 shows an arrangement of four coke oven chambers (1) that are united to form a coke oven bank (2). These coke oven chambers (1) are equipped with additional burners (3). The coke oven chambers (1) are empty when the coke cake has been pushed. The hot flue gas (4) is conducted into the flue gas channel (5) which extends via a common flue gas channel (6) to finally terminate in the boiler (7). The common flue gas channel (6) upstream to the boiler (7) can be equipped with a flue gas distributor (8). The hot flue gas (4) is exploited in the boiler (7) to generate steam which in turn is utilized to generate electricity (9). The boiler (7) must be supplied with flue gas (4) having a temperature which is constant throughout the whole period of time. According to the present invention, a compensation burner (10) feeding additional flue gas into the common flue gas channel (6) is arranged at the common flue gas channel (6) upstream to the flue gas distributor (8). The cooled flue gas (11) is discharged after it has passed through the boiler (7).

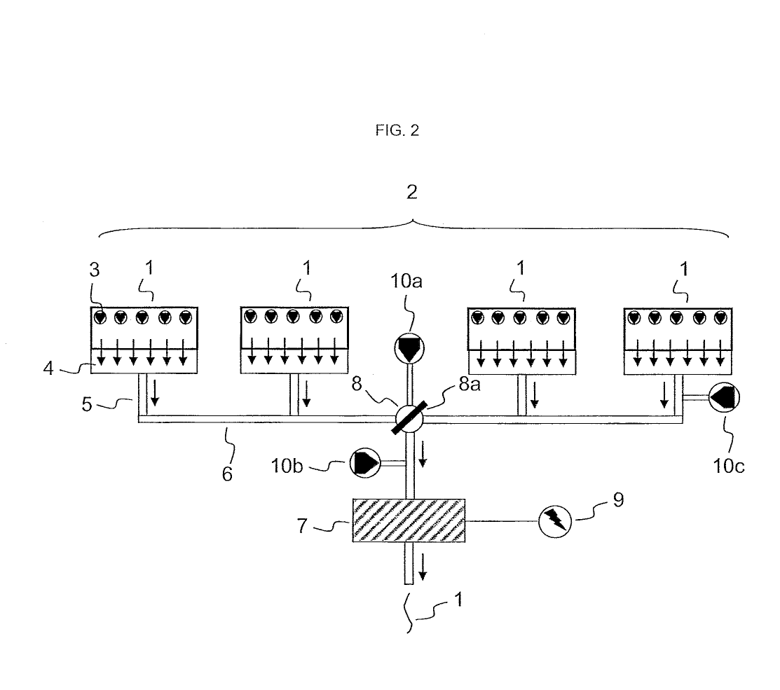

FIG. 2 shows the same arrangement of four coke oven chambers (1) that are united to form a coke oven bank (2). The hot flue gas (4) is conducted into the flue gas duct (5) which extends via a common flue gas channel (6) to finally terminate in the boiler (7). The common flue gas channel (6) upstream to the boiler (7) is equipped with an emergency chimney (12) which on operation of the compensation burners (10a-c) can be locked with an appropriate device (12a). Here, the compensation burners (10a) are arranged both upstream to the emergency chimney (12) and directly upstream (10b) to the boiler (7) as well as (10c) at the discharge duct (5) for flue gas (11) which feeds additional flue gas into the common flue gas channel (6). The cooled waste gas (11) is discharged after it has passed through the boiler (7)

### LIST OF REFERENCE NUMBERS

1 Coke oven chamber

2 Coke oven bank

3 Additional burner

4 Hot flue gas

5 Flue gas channel

6 Common flue gas channel

7 Boiler

8 Flue gas distributor

9 Electricity

10 A compensation burner

10a-c Several compensation burners

11 Discharge duct for flue gas

12 Emergency chimney

12a Locking device for emergency chimney

1. A method for compensation of flue gas enthalpy losses from “Heat Recovery” coke ovens, wherein
a number of coke oven chambers is linked to a coke oven bank connected to at least one boiler which utilizes the hot flue gas from the coke oven banks to generate steam or heated water, and
the operation of coke oven chambers is periodically interrupted, removing coke from the coke oven chambers, and
in normal operation the coking gas is utilized to heat the coke cake by combustion with air and to supply the heat required for coal carbonization so that a hot flue gas is produced, and
the individual coke oven chambers during the period of scheduled or non-scheduled operational interruption are kept warm with at least one foreign-heated additional burner so that a hot flue gas originating from the flue gas of the additional burners is also provided during the period of operational interruption or delay,
wherein
the heat flow which is reduced as compared with normal operation is compensated for by at least one additional compensation burner located outside the coke oven chambers so that the boiler(s) is (are) supplied with a heat flow that is constant as compared with normal operation.

2. The method for compensation of flue gas enthalpy losses from “Heat Recovery” coke ovens according to claim 1, wherein during an operational interruption or delay, the heat flow of flue gas is reduced by up to 50 percent without additional compensation burners outside the coke oven chambers.

3. The method for compensation of flue gas enthalpy losses from “Heat Recovery” coke ovens according to claim 1, wherein the heat flow of flue gas in a temporally constant manner is brought back to 100 percent or nearly 100 percent of the heat flow of normal operation by way of the additional compensation burners arranged outside the coke oven chambers.

4. The method for compensation of flue gas enthalpy losses from “Heat Recovery” coke ovens according to claim 1, wherein the additional compensation burner(s) arranged outside the coke oven chambers is (are) operated with a fuel containing hydrocarbons.

5. The method for compensation of flue gas enthalpy losses from “Heat Recovery” coke ovens according to claim 4, wherein the additional compensation burner(s) outside the coke oven chambers is (are) operated with natural gas.

6. The method for compensation of flue gas enthalpy losses from “Heat Recovery” coke ovens according to claim 4, wherein the additional compensation burner(s) outside the coke oven chambers is (are) operated with coke oven gas.

7. The method for compensation of flue gas enthalpy losses from “Heat Recovery” coke ovens according to claim 4, wherein the additional compensation burner(s) outside the coke oven chambers is (are) operated with liquefied gas.

8. The method for compensation of flue gas enthalpy losses from “Heat Recovery” coke ovens according to claim 1, wherein the heat flow of flue gas is utilized to generate steam by means of the boilers and that the steam is utilized to generate electric current.

9. The method for compensation of flue gas enthalpy losses from “Heat Recovery” coke ovens according to claim 1, wherein the additional compensation burner(s) is (are) arranged directly upstream to the boiler(s).

10. The method for compensation of flue gas enthalpy losses from “Heat Recovery” coke ovens according to claim 1, wherein a lockable emergency chimney is arranged between the flue gas collecting channel and the boiler(s) and that the additional compensation burner(s) is (are) arranged directly upstream to the emergency chimney.

11. The method for compensation of flue gas enthalpy losses from “Heat Recovery” coke ovens according to claim 1, wherein the additional compensation burner(s) is (are) arranged in the flue gas channel between the oven and the boiler.
